(19) United States
(12) Patent Application Publication
(10) Pub. No.: US 2019/0154129 A1
(43) Pub. Date: May 23, 2019

(54) INTEGRATED CAM SHAFT ASSEMBLY

(71) Applicant: Medela Holding AG, Baar (CH)

(72) Inventor: Joseph Wach, Ingleside, IL (US)

(21) Appl. No.: 16/184,852

(22) Filed: Nov. 8, 2018

Related U.S. Application Data
(60) Provisional application No. 62/589,195, filed on Nov. 21, 2017.

(51) Int. Cl. F16H 53/02; F16H 57/00

(52) U.S. Cl. CPC F16H 53/025; F16H 57/0025

(57) ABSTRACT

A cam shaft assembly including a shaft defining a shaft longitudinal axis. The cam shaft assembly further including a gear attached to and extending radially about the shaft. The cam shaft assembly further including a cam attached to the shaft. The cam and the shaft are formed of a single contiguous piece of material. In an embodiment, the gear, the cam and the shaft may all be formed of a single contiguous piece of material. In another embodiment the cam and the shaft are formed of a first material and the gear is formed of a second material.

### CROSS-REFERENCE TO RELATED APPLICATIONS

This application relates to, claims the benefit of and priority to U.S. Provisional Patent Application No. 62/589,195, entitled INTEGRATED CAM SHAFT ASSEMBLY, filed Nov. 21, 2017, the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present disclosure relates generally to cam shaft systems. More particularly, the present disclosure relates to a cam shaft assembly with an integrated cam shaft with gear.

### 2. Related Art

Reciprocating device assemblies can include one or more gears for providing motor driven rotational movement to a cam on a rotatable shaft. The gear or gear train can transfer power from a motor to rotate the shaft for a variety of applications, such as to generate pressure in an associated chamber connected via an arm to an output of the cam. In certain applications, the shaft must pass through a gear box for housing the gear or gear train to facilitate the transfer of power to the cam.

As illustrated in FIG. 1, there is depicted a known prior art cam shaft system 10 that includes a gear 12 that is connectable to a shaft 14, directly or indirectly, wherein the shaft 14 can be positioned through an opening in a gearbox. A bushing 16 is provided in the opening to enable substantially unimpeded rotation of the section of shaft 14 disposed in the opening during operation. A cam 18 can be connected to the shaft 14 via a retaining ring 20.

In view of the foregoing, there is a need in the art for an improved cam shaft assembly in comparison to the prior art.

### BRIEF SUMMARY

In accordance with one embodiment, there is provided a cam shaft assembly. The cam shaft assembly includes a shaft defining a shaft longitudinal axis, a gear attached to and extending radially about the shaft, and a cam attached to the shaft. The cam and the shaft are formed of a single contiguous piece of material.

According to various embodiments, the gear, the cam and the shaft all may be formed of a single contiguous piece of material. In another embodiment, the cam and the shaft are formed of a first material and the gear is formed of a second material. The shaft may have a distal end and an opposing end, and the cam may be disposed generally at the distal end. The cam may extend from the distal end parallel to the shaft longitudinal axis. The cam may have a contiguous cam outer surface disposed parallel to the shaft longitudinal axis. The cam may be radially off-set from the shaft longitudinal axis. An entirety of the cam may translate along a circular path about the shaft longitudinal axis upon rotation of the shaft about the shaft longitudinal axis. The cam shaft assembly may further include a housing, and the shaft may extend in the housing. The housing has a housing body, a housing inner cavity and an aperture formed in the housing body extending to the housing inner cavity, and the shaft longitudinal axis may extend through the aperture. The housing may further have a housing base, and the housing body and the housing base may be cooperatively sized and configured to engage each other with the shaft disposed in the housing. The housing may have a housing inner cavity, and the housing inner cavity may have an housing inner surface disposed concentrically about the shaft longitudinal axis. The housing inner surface may be disposed in slidable contact with the shaft upon rotation of the shaft about the shaft longitudinal axis. The housing may have a housing body and an aperture formed in the housing body extending to the housing inner cavity, and the shaft longitudinal axis may extend through the aperture with the housing inner surface being disposed adjacent the aperture. The housing may have a shaft guide. The shaft may have a shaft inner surface disposed concentrically about the shaft guide and the shaft longitudinal axis, and the shaft guide may be disposed in slidable contact with the shaft inner surface upon rotation of the shaft about the shaft longitudinal axis.

The cam shaft assembly includes a shaft defining a shaft longitudinal axis, a gear attached to and extending radially about the shaft, and a cam attached to the shaft. The gear and the shaft are formed of a single contiguous piece of material. The gear and the shaft may be formed of a first material and the cam is formed of a second material.

According to another embodiment, there is provided a cam shaft assembly. The cam shaft assembly includes a shaft defining a shaft longitudinal axis. The shaft has an inner surface. The cam shaft assembly further includes a gear attached to and extending radially about the shaft. The cam shaft assembly further includes a cam attached to the shaft. The cam, the gear and the shaft all are formed of a single contiguous piece of material. The cam shaft assembly further includes a housing. The shaft extends into the housing. The housing is sized and configured to support the shaft with respect to movement orthogonal to the shaft longitudinal axis without any bushing between the housing and the shaft. The housing includes a housing inner cavity having a housing inner surface disposed concentrically about the shaft longitudinal axis. The housing inner surface is disposed in slidable contact with the shaft upon rotation of the shaft about the shaft longitudinal axis. The housing further includes a shaft guide. The shaft inner surface is disposed concentrically about the shaft guide and the shaft longitudinal axis. The shaft guide is disposed in slidable contact with the shaft inner surface upon rotation of the shaft about the shaft longitudinal axis. Further, the gear, the cam and the shaft all may be formed of a single contiguous piece of material. In another embodiment, the cam and the shaft are formed of a first material and the gear is formed of a second material. The housing may have a housing body and an aperture formed in the housing body extending to the housing inner cavity. The shaft longitudinal axis extends through the aperture, and the housing inner surface is disposed adjacent the aperture.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a side view of a prior art cam shaft assembly;

FIG. 2 is an exploded elevated side view of a cam shaft assembly according to an embodiment of the invention;

FIG. 3 is a cross-sectional side view of the cam shaft assembly of FIG. 2 as seen along axis 3-3 that includes an integrated cam shaft;

FIG. 4a is a top view of the cam shaft assembly;

FIG. 4b is a front view of the cam shaft assembly;

FIG. 4c is a side view of the cam shaft assembly; and

FIG. 4d is a rear view of the cam shaft assembly.

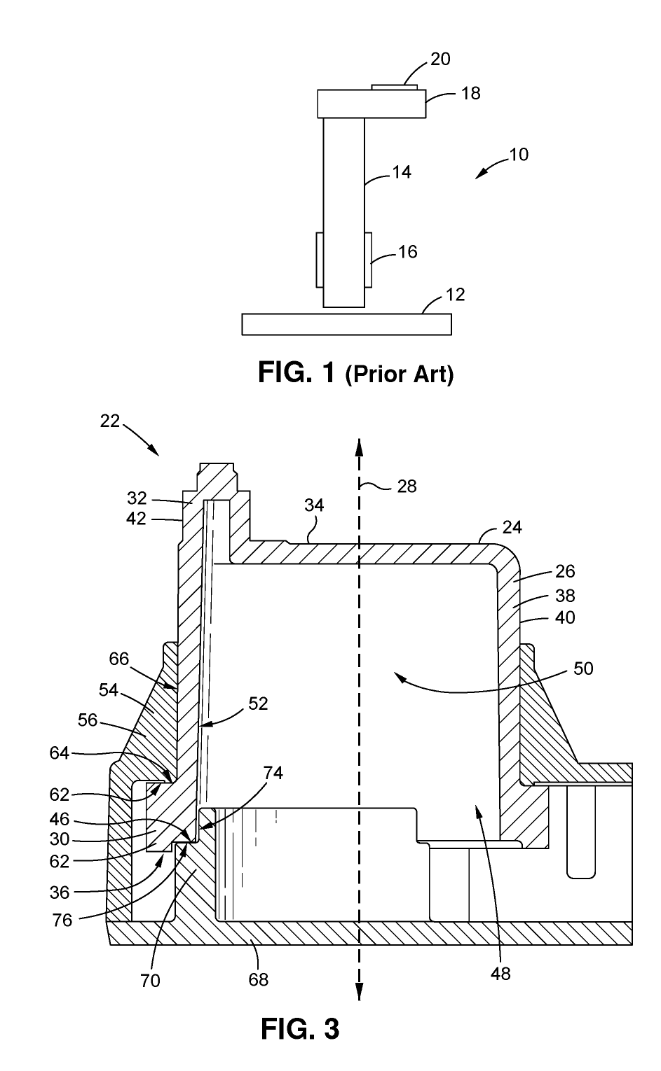

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as top and bottom, first and second, and the like are used solely to distinguish one entity from another without necessarily requiring or implying any actual such relationship or order between such entities. Further, the various features of the embodiments disclosed herein can be used alone, or in varying combinations with each other and are not intended to be limited to the specific combination described herein. Thus, the scope of the claims is not to be limited by the illustrated embodiments.

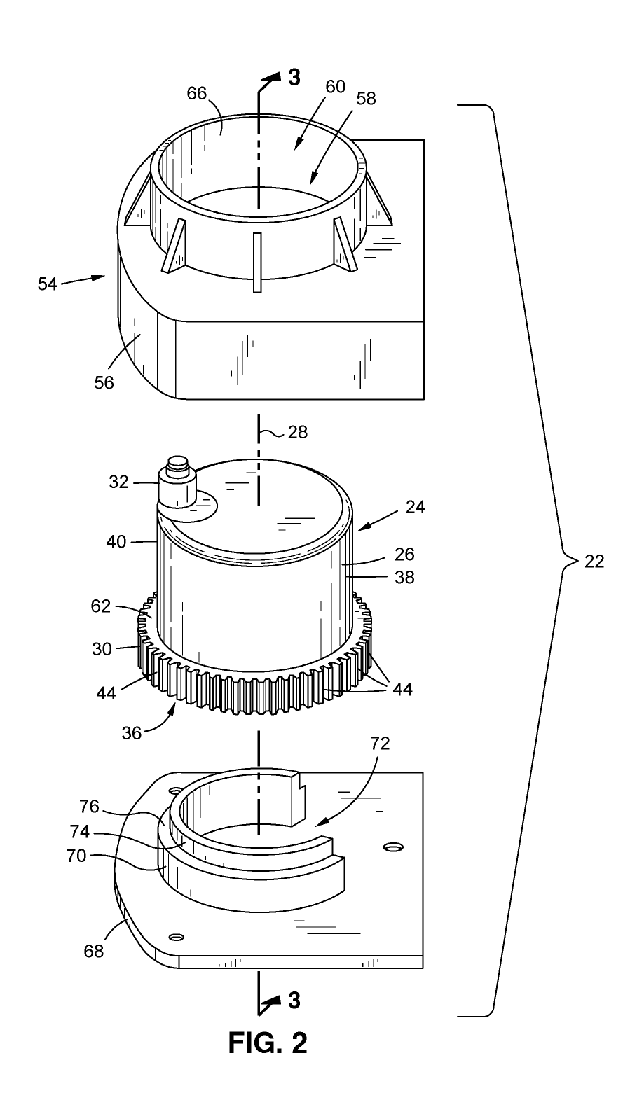

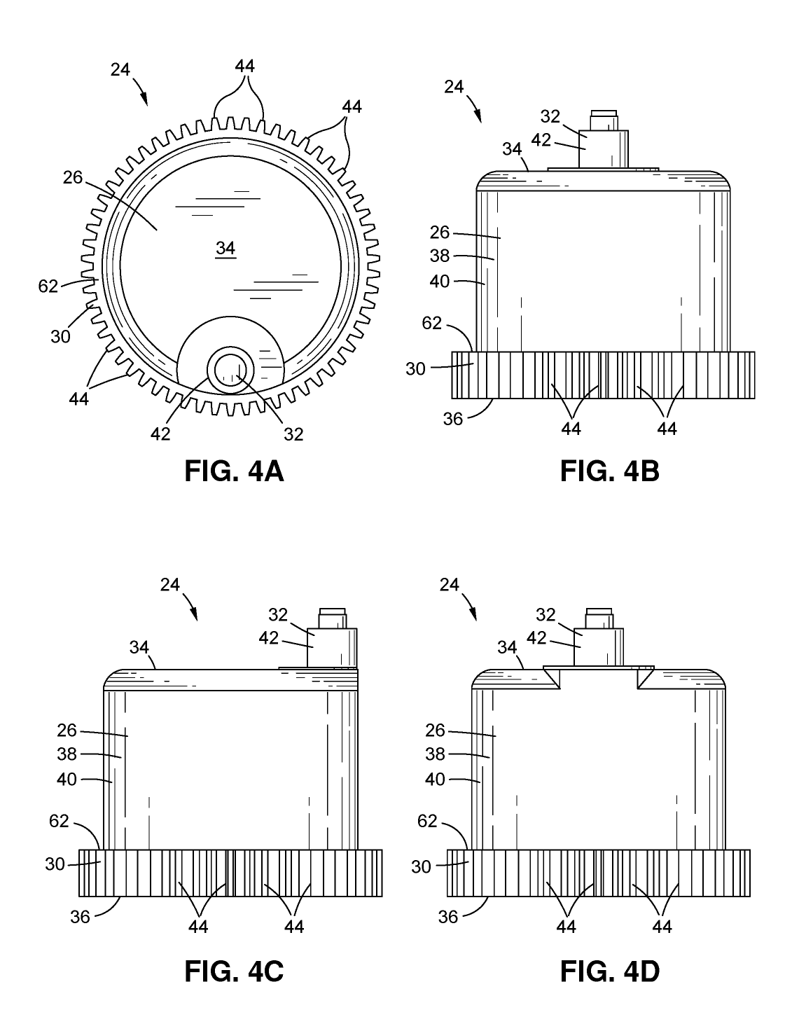

Referring now to FIG. 2 there is depicted an exploded elevated side view of a cam shaft assembly 22 according to an embodiment of the invention. FIG. 3 is a cross-sectional side view of the cam shaft assembly 22 of FIG. 2 as seen along axis 3-3 that includes an integrated cam shaft 24. FIG. 4a is a top view of the cam shaft assembly 22. FIG. 4b is a front view of the cam shaft assembly 22. FIG. 4c is a side view of the cam shaft assembly 22. FIG. 4d is a rear view of the cam shaft assembly 22.

According to an embodiment of the invention, there is provided the cam shaft assembly 22 that includes the integrated cam shaft 24. The integrated cam shaft 24 includes a shaft 26 defining a shaft longitudinal axis 28. The integrated cam shaft 24 further includes a gear 30 attached to and extending radially about the shaft 26. Integrated cam shaft 24 further includes a cam 32 attached to the shaft 26. The cam 32 and the shaft 26 are formed of a single contiguous piece of material.

According to various embodiments, the gear 30, the cam 32 and the shaft 26 all may be formed of a single contiguous piece of material. For example, the gear 30, the cam 32 and the shaft 26 of the integrated cam shaft 24 may be formed of an injection molded plastic. In another embodiment, the cam 32 and the shaft 26 are formed of a first material and the gear 30 is formed of a second material. For example, the cam 32 and the shaft 26 may be formed of an injection molded plastic and the gear 30 may be formed of a harder or tougher plastic material or metal, such as where the tolerances and/or wear resistance is of importance. In this regard, the gear 30 may be over-molded with injection molded plastic to form the cam 32 and the shaft 26. In another embodiment, the gear 30 and the shaft 26 are formed of a first material and the cam 32 is formed of a second material. For example, the gear 30 and the shaft 26 may be formed of an injection molded plastic and the cam 32 may formed of harder or tougher plastic material or metal, such as where the tolerances and/or wear resistance is of importance. Where the components of the integrated cam shaft 24 are formed of differing materials, the components may formed to be complementary so as to ease the assembly thereof, such as being able to be snap fit together. Preferably such assembly would be without the need for additional fasteners or adhesives.

Common to the foregoing embodiments is the efficiencies associated with integrally forming components of the integrated cam shaft 24. It is contemplated that such various embodiments achieve a compact cam shaft assembly design that does not require a bushing (bushingless) or retaining ring in order to translate rotation movement from the gear 30 to the cam 32. As will be appreciated, the cam shaft assembly 22 disclosed herein may be used to deliver a wide range of rotational output to a device via the cam 32 while having an efficient output using a minimal or a relatively few number of assembly components.

The material selection and fabrication techniques for the integrated cam shaft 24, and components thereof, may be chosen from those which are well known to one of ordinary skill in the art depending upon the particular constraints, including component performance and durability, manufacturing ease and cost. Further, in the embodiment depicted, the aspect ratio of the length of the shaft 26 to the diameter of the shaft 26 is relatively low with the length and diameter being on the same order. However, the dimensioning may be of any proportion, such as with the length being many times greater than the diameter of the shaft 26 and the shape of the shaft 26 being more elongate.

According to an embodiment of the invention, the shaft 26 may have a distal end 34, an opposing end 36 and a shaft body 38 disposed there between. The shaft body 38 has a shaft outer surface 40. The cam 32 may be disposed generally at the distal end 34 of the shaft 26. The cam 32 may extend from the distal end 34 parallel to the shaft longitudinal axis 28. The cam 32 may be radially off-set from the shaft longitudinal axis 28. An entirety of the cam 32 may translate along a circular path about the shaft longitudinal axis 28 upon rotation of the shaft 26 about the shaft longitudinal axis 28. In this regard, it is understood that a reciprocating circular rotational movement may be translated to any number of components (such as an arm not shown) as may be required. The cam 32 may have a contiguous cam outer surface 42 disposed parallel to the shaft longitudinal axis 28. The cam outer surface 42 may simply be cylindrical shaped, other non-cylindrical shapes are contemplated. In such a non-circular configuration, the cam 32 may be generally centered along the shaft longitudinal axis 28, with the cam 32 rotating upon rotation of the shaft 26. It is understood that in such an embodiment, that a cam follower would be used to engage the cam outer surface 42 to provide the desired transfer of mechanical output.

The gear 30 may extend radially from the shaft 26 at the shaft opposing end 36, as depicted in the embodiment shown. However, the gear 30 may be located at other longitudinal positions along the shaft body 38. The gear 30 may be a multitude of gear teeth 44 that extend radially from the shaft body 38. The gear teeth 44 may be oriented in other directions such as parallel to the shaft longitudinal axis 28. It is contemplated that the particular configuration and specifications for the gear 30 may be chosen from those which are well known to one of ordinary skill in the art depending upon the desired output requirements.

A first annular support surface 46 (as depicted in FIG. 3) may be disposed at the opposing end 36 of the shaft 26. The first annular support surface 46 may be disposed about a bottom opening 48 (as depicted in FIG. 3) formed in the opposing end 36. The bottom opening 48 extends to a shaft inner cavity 50 (as depicted in FIG. 3). The shaft 26 may further have a shaft inner surface 52 (as depicted in FIG. 3) that defines the shaft inner cavity 50.

The cam shaft assembly 22 may further include a housing 54. As the cam shaft assembly 22 includes the gear 30 and the housing 54 this arrangement may be referred to as a gear box. The integrated cam shaft 24 extends in the housing 54. The housing 54 has a housing body 56, a housing inner cavity 58 and an aperture 60 formed in the housing body 56 extending to the housing inner cavity 58. The shaft longitudinal axis 28 may extend through the aperture 60. In the embodiment illustrated the integrated cam shaft 24 is partially disposed in the housing 54.

The housing inner cavity 58 is defined by a housing inner surface 62 disposed concentrically about the shaft longitudinal axis 28. The housing inner surface 62 extends to the aperture 60. The shaft 26 may extend through the aperture 60 away from the housing 54. Portions of the shaft body 38 are disposed within and outside of the housing body 56. The cam 32 may extend beyond the aperture 60 away from the housing 54. The housing inner cavity 58 may be complementarily formed with the shaft outer surface 40. The shaft 26 is disposed in the housing 54, in particular with the shaft body 38 in the housing inner cavity 58 with the shaft outer surface 40 closely fit with the housing inner surface 62. The housing inner surface 62 may be disposed in slidable contact with the shaft 26 upon rotation of the shaft 26 about the shaft longitudinal axis 28. The shaft outer surface 40 slides within the housing inner surface 62 upon rotation of the shaft 26. As such, the shaft 26 is laterally supported by the housing inner surface 62 adjacent the aperture 60 in a collar-like arrangement. This allows the shaft 26 to be supported without the need for any bushing at such location.

The shaft 26 includes a second annual support surface 62 that is disposed along the shaft outer surface 40 adjacent the gear 30. The gear 30 is disposed longitudinally between the first annual support surface 46 and the second annular support surface 62. The housing 54 further includes a housing shoulder 64 (as depicted in FIG. 3). The housing shoulder 64 is disposed in slidable contact with the second annular support surface 62 of the shaft 26. The second annular support surface 62 slides along the housing shoulder 64 upon rotation of the shaft 26 about the shaft longitudinal axis 28. As such, the shaft 26 is longitudinally supported by the housing shoulder 64 and does not allow the shaft 26 to move in a direction away from the housing base 68. This further allows the shaft 26 to be supported without the need for any bushing at such location.

The housing 54 may further have a housing base 68. The housing body 56 and the housing base 68 are cooperatively sized and configured to engage each other with the shaft 26 disposed in the housing inner cavity 58 of the housing 54. The opposing end 36 of the shaft 26 is disposed adjacent the housing base 64. The housing 54, and more specifically, the housing base 68 may have a shaft guide 70.

The shaft guide 70 is configured to extend upwardly into the shaft inner cavity 50 and interact with the shaft 26 as further discussed below. The shaft guide 70 in this embodiment is generally arcuate shaped with an opening 72 (as depicted in FIG. 2) in the arcuate shape for providing access to the gear teeth 44 for mechanical linkage thereto. The shaft guide 70 is disposed in slidable contact with the shaft inner surface 52 upon rotation of the shaft 26 about the shaft longitudinal axis 28.

In this embodiment, the shaft guide 70 has an arcuate outer guide surface 74 and a base shoulder 76. The base shoulder 76 is disposed adjacent the outer guide surface 74 and are generally orthogonal to each other. The outer guide surface 74 is disposed in slidable contact with the shaft inner surface 52 upon rotation of the shaft 26 about the shaft longitudinal axis 28. The shaft inner surface 52 slides about the outer guide surface 74 upon rotation of the shaft 26 about the shaft longitudinal axis 28. As such, the shaft 26 is laterally supported by the outer guide surface 74. This allows the shaft 26 to be further supported without the need for any bushing at such location. The base shoulder 76 is disposed in slidable contact with the first annular support surface 46 of the shaft 26. The first annular support surface 46 slides along the shoulder 76 upon rotation of the shaft 26 about the shaft longitudinal axis 28. As such, the shaft 26 is longitudinally supported by the base shoulder 76 and does not allow the shaft 26 to move in a direction towards the housing base 64. This further allows the shaft 26 to be supported without the need for any bushing at such location.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A cam shaft assembly comprising:
a shaft defining a shaft longitudinal axis;
a gear attached to and extending radially about the shaft; and
a cam attached to the shaft, the cam and the shaft being formed of a single contiguous piece of material.

2. The cam shaft assembly of claim 1 wherein the gear, the cam and the shaft all are formed of a single contiguous piece of material.

3. The cam shaft assembly of claim 1 wherein the cam and the shaft are formed of a first material and the gear is formed of a second material.

4. The cam shaft assembly of claim 1 wherein the shaft has a distal end and an opposing end, the cam is disposed generally at the distal end.

5. The cam shaft assembly of claim 4 wherein the cam extends from the distal end parallel to the shaft longitudinal axis.

6. The cam shaft assembly of claim 1 wherein the cam has a contiguous cam outer surface disposed parallel to the shaft longitudinal axis.

7. The cam shaft assembly of claim 1 wherein the cam is radially off-set from the shaft longitudinal axis.

8. The cam shaft assembly of claim 7 wherein an entirety of the cam translates along a circular path about the shaft longitudinal axis upon rotation of the shaft about the shaft longitudinal axis.

9. The cam shaft assembly of claim 1 further includes a housing, the shaft extends in the housing.

10. The cam shaft assembly of claim 9 wherein the housing has a housing body, a housing inner cavity and an aperture formed in the housing body extending to the housing inner cavity, the shaft longitudinal axis extends through the aperture.

11. The cam shaft assembly of claim 9 wherein the housing further has a housing base, the housing body and the housing base are cooperatively sized and configured to engage each other with the shaft disposed in the housing.

12. The cam shaft assembly of claim 9 wherein the housing has a housing inner cavity, the housing inner cavity has a housing inner surface disposed concentrically about the shaft longitudinal axis, the housing inner surface is disposed in slidable contact with the shaft upon rotation of the shaft about the shaft longitudinal axis.

13. The cam shaft assembly of claim 12 wherein the housing has a housing body and an aperture formed in the housing body extending to the housing inner cavity, the shaft longitudinal axis extends through the aperture, the housing inner surface is disposed adjacent the aperture.

14. The cam shaft assembly of claim 9 wherein the housing has a shaft guide, the shaft has a shaft inner surface disposed concentrically about the shaft guide and the shaft longitudinal axis, the shaft guide is disposed in slidable contact with the shaft inner surface upon rotation of the shaft about the shaft longitudinal axis.

15. A cam shaft assembly comprising:
a shaft defining a shaft longitudinal axis;
a cam attached to the shaft; and
a gear attached to and extending radially about the shaft; the gear and the shaft being formed of a single contiguous piece of material.

16. The cam shaft assembly of claim 15 wherein the gear and the shaft are formed of a first material and the cam is formed of a second material.

17. A cam shaft assembly comprising:
a shaft defining a shaft longitudinal axis, the shaft having an inner surface;
a gear attached to and extending radially about the shaft;
a cam attached to the shaft, the cam, the gear and the shaft all being formed of a single contiguous piece of material; and
a housing, the shaft extending into the housing, the housing being sized and configured to support the shaft with respect to movement orthogonal to the shaft longitudinal axis without any bushing between the housing and the shaft, the housing having:
an housing inner cavity having an housing inner surface disposed concentrically about the shaft longitudinal axis, the housing inner surface being disposed in slidable contact with the shaft upon rotation of the shaft about the shaft longitudinal axis; and
a shaft guide, the shaft inner surface being disposed concentrically about the shaft guide and the shaft longitudinal axis, the shaft guide being disposed in slidable contact with the shaft inner surface upon rotation of the shaft about the shaft longitudinal axis.

18. The cam shaft assembly of claim 17 wherein the gear, the cam and the shaft all are formed of a single contiguous piece of material.

19. The cam shaft assembly of claim 17 wherein the cam and the shaft are formed of a first material and the gear is formed of a second material.

20. The cam shaft assembly of claim 17 wherein the housing has a housing body and an aperture formed in the housing body extending to the housing inner cavity, the shaft longitudinal axis extends through the aperture, the housing inner surface is disposed adjacent the aperture.
